(19) United States
(12) Patent Application Publication
(10) Pub. No.: US 2025/0337196 A1
(43) Pub. Date: Oct. 30, 2025

(54) LEVER-TYPE CONNECTOR

(71) Applicant: SUMITOMO WIRING SYSTEMS, LTD., Mie (JP)

(72) Inventors: Tsuyoshi MASE, Mie (JP); Toshihiro ITO, Mie (JP); Takahiro KIKUCHI, Mie (JP)

(21) Appl. No.: 18/871,487

(22) PCT Filed: Jun. 2, 2023
(86) PCT No.: PCT/JP2023/020638

§ 371 Date: Dec. 4, 2024

(30) Foreign Application Priority Data
Jun. 10, 2022 (JP) 2022-094103

(51) Int. Cl. H01R 13/629; H01R 13/10; H01R 13/506

(52) U.S. Cl. CPC H01R 13/62938; H01R 13/10; H01R 13/506; H01R 13/62955

(57) ABSTRACT

A lever-type connector includes: a connector housing that has a fitting surface and a first lever attachment surface different from the fitting surface and is fitted to a partner connector, a front holder that has a front wall disposed along the fitting surface and a peripheral wall extending from the front wall and disposed along the first lever attachment surface, and a lever that is attached to the connector housing such that it can rotate from an initial position to a fitting completion position, the connector housing includes: a first lock arm that has the first arm portion flexibly disposed on the first lever attachment surface and the first lock protrusion that protrudes from the first arm portion, and is engaged with the lever when the lever is at the initial position, and the peripheral wall covers the first arm portion.

### TECHNICAL FIELD

A technique disclosed in the present specification relates to a lever-type connector.

### BACKGROUND

Lever-type connectors each include a lever for assisting fitting and detachment to and from a partner connector based on the principle of leverage. The lever is attached to a housing, and is pivotally supported such that the lever can rotate between an initial position and a fitting completion position where the partner connector is in a state of being fitted to the housing at a proper fitting position. This type of lever-type connector may include a latching portion for holding the lever at the initial position when the connector is not fitted to the partner connector. The latching portion includes a flexible latching plate and a latching step portion that protrudes from the latching plate and is engaged with the lever. When the connector is fitted with the partner connector, the latching plate flexes by the latching step portion being pressed by the partner connector, and engagement with the lever is released, enabling rotation of the lever to the fitting completion position (see Patent Document 1).

### PRIOR ART DOCUMENT

### Patent Document

Patent Document 1: JP 2003-317853 A

### SUMMARY OF THE INVENTION

### Problems to be Solved

In the above connector, there has been concern that the latching plate will deform due to action of an unexpected external force, and there has been demand for improvement.

### Means to Solve the Problem

A lever-type connector disclosed in the present specification is a lever-type connector disclosed in the present specification that includes: a connector housing that has a fitting surface and a lever attachment surface different from the fitting surface, and is fitted to a partner connector, a front member that has a front wall disposed along the fitting surface and a peripheral wall extending from the front wall and disposed along the lever attachment surface, and a lever that is attached to the connector housing such that the lever is rotatable from an initial position to a fitting completion position, the connector housing includes a lock arm that has an arm body that is flexibly disposed on the lever attachment surface, and a lock protrusion that protrudes from the arm body, and is engaged with the lever when the lever is at the initial position, and the peripheral wall covers the arm body.

### Effect of the Invention

In a lever-type connector disclosed in the present specification, it is possible to avoid unexpected deformation of a lock arm due to action of an external force.

### BRIEF DESCRIPTION OF THE DRAWINGS

FIG. 1 is a perspective view of a lever-type connector according to an embodiment of the present disclosure.

FIG. 2 is an exploded perspective view of the lever-type connector according to the embodiment.

FIG. 3 is an exploded perspective view of a connector housing and a front holder according to the embodiment.

FIG. 4 is a plan view of the lever-type connector according to the embodiment.

FIG. 5 is a side view of the connector housing according to the embodiment.

FIG. 6 is a partially enlarged cross-sectional view showing the connector housing according to the embodiment, cut along the line A-A in FIG. 5.

FIG. 7 is a side view of the lever-type connector according to the embodiment.

FIG. 8 is a cross-sectional view taken along the line B-B in FIG. 7.

FIG. 9 is a perspective view of the front holder according to the embodiment.

FIG. 10 is a perspective view of a partner connector according to the embodiment.

FIG. 11 is a front view of the partner connector according to the embodiment.

FIG. 12 is a side view showing a state of initial fitting between the lever-type connector and the partner connector according to the embodiment.

FIG. 13 is a partially enlarged cross-sectional view cut along the line C-C in FIG. 12, showing a state of initial fitting between the lever-type connector and the partner connector according to the embodiment.

FIG. 14 is a side view showing a state where fitting between the lever-type connector and the partner connector is complete according to the embodiment.

FIG. 15 is a partially enlarged cross-sectional view cut along the line D-D in FIG. 14, showing a state where fitting between the lever-type connector and the partner connector is complete according to the embodiment.

### DETAILED DESCRIPTION TO EXECUTE THE INVENTION

### Summary of Embodiments

(1) A lever-type connector disclosed in the present specification includes: a connector housing that has a fitting surface and a lever attachment surface different from the fitting surface, and is fitted to a partner connector, a front member that has a front wall disposed along the fitting surface and a peripheral wall extending from the front wall and disposed along the lever attachment surface, and a lever that is attached to the connector housing such that the lever is rotatable from an initial position to a fitting completion position, the connector housing includes a lock arm that has an arm portion that is flexibly disposed on the lever attachment surface, and a lock protrusion that protrudes from the arm portion, and is engaged with the lever when the lever is at the initial position, and the peripheral wall covers the arm portion.

With the above configuration, the arm portion is covered and protected by the peripheral wall, and thus it is possible to avoid unexpected deformation of the lock arm due to an external force being applied. In addition, the peripheral wall of the front member is used as the protection wall of the lock arm, and thus the lock arm can be protected without increasing the size of the connector.

(2) In the lever-type connector of the above (1), the peripheral wall may be disposed adjacent to the lock protrusion, on an opposite side to the lever.

According to such a configuration, the holding force of the lock protrusion for holding the lever is assisted by the peripheral wall, and thus it is possible to reliably restrict unexpected rotation of the lever to the fitting completion position.

(3) In the lever-type connector of the above (1) or (2), the lock protrusion may include a first protrusion portion that has a lever engagement surface that is engaged with the lever when the lever is at the initial position, and a second protrusion portion that has a guide surface inclined in a direction separating away from the fitting surface as it separates away from the arm portion.

According to such a configuration, since the lock protrusion includes a plurality of protrusion portions, and thus the protrusion portions can be assigned different roles, thus increasing the degree of freedom of design.

(4) In the lever-type connector of any one of the above (1) to (3), the connector housing may include: a terminal holding portion that has a cavity capable of accommodating a terminal fitting, and a lock arrangement portion disposed at a position different from the terminal holding portion, and the lock arrangement portion may include the lock arm and a fitting completion holding portion that is engaged with the lever when the lever is at the fitting completion position.

With such a configuration, by collectively disposing, in the lock arrangement portion, a structure for holding the lever at the initial position and the fitting completion position, it is possible to avoid complexity in the configuration of the connector housing.

### Detailed Description of Embodiments

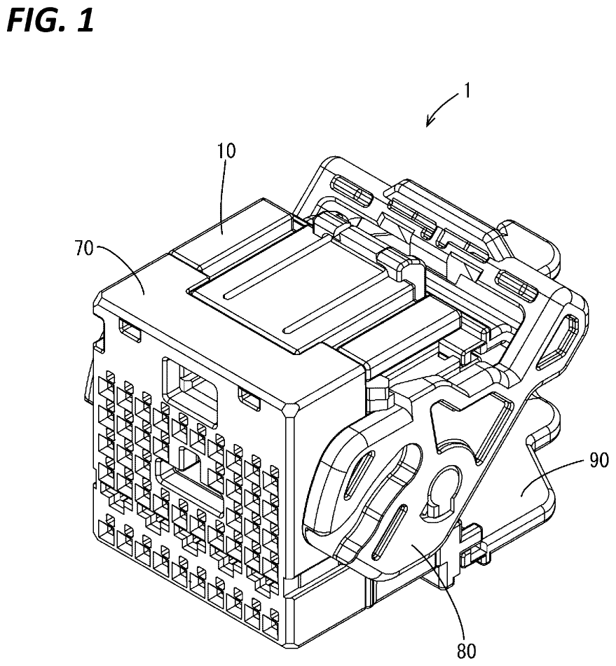

Specific examples of a technique disclosed in the present specification will be described later with reference to FIGS. 1 to 15. Note that the present invention is not limited to these examples, but rather is indicated by the claims, and includes all modifications that are within the meanings and the scope that are equivalent to those of the claims.

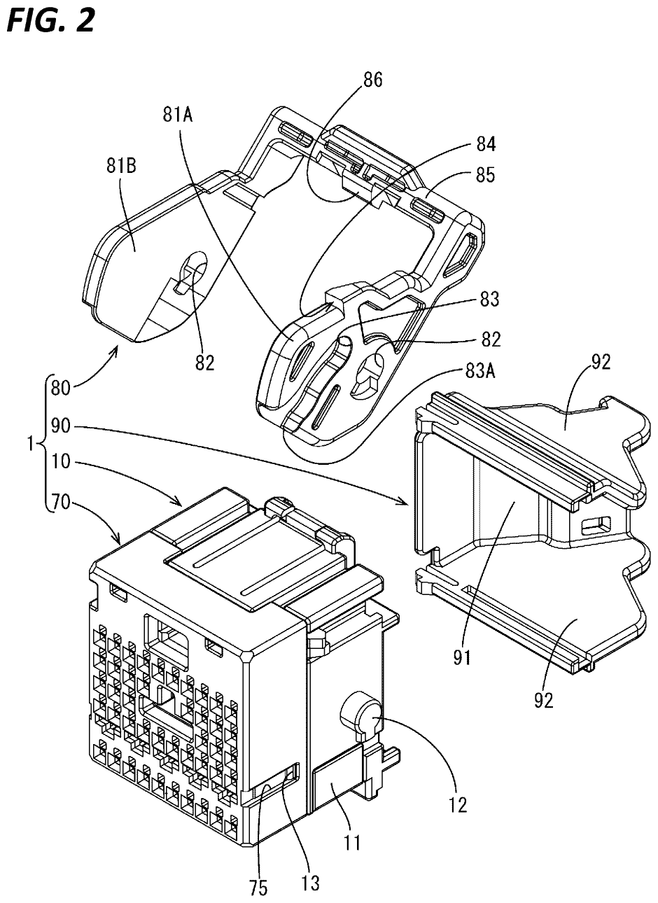

A lever-type connector 1 according to the present embodiment is a connector that is to be fitted to a partner connector 100, and, as shown in FIGS. 1 and 2, includes a connector housing 10 that holds a terminal fitting connected to a terminal of an electric wire, a front holder 70 attached to the connector housing 10, a lever 80 attached to the connector housing 10 such that the lever 80 is rotatable between an initial fitting position and a fitting completion position, and an electric wire cover 90 attached to the connector housing 10 to protect the electric wire. In the following description, a direction in which the lever-type connector 1 is fitted to the partner connector 100 (lower left-upper right direction in FIG. 1) is defined as a front-rear direction, and a side on which the partner connector 100 is attached to the lever-type connector 1 (lower left side in FIG. 1) is defined as a front side.

### [Connector Housing 10]

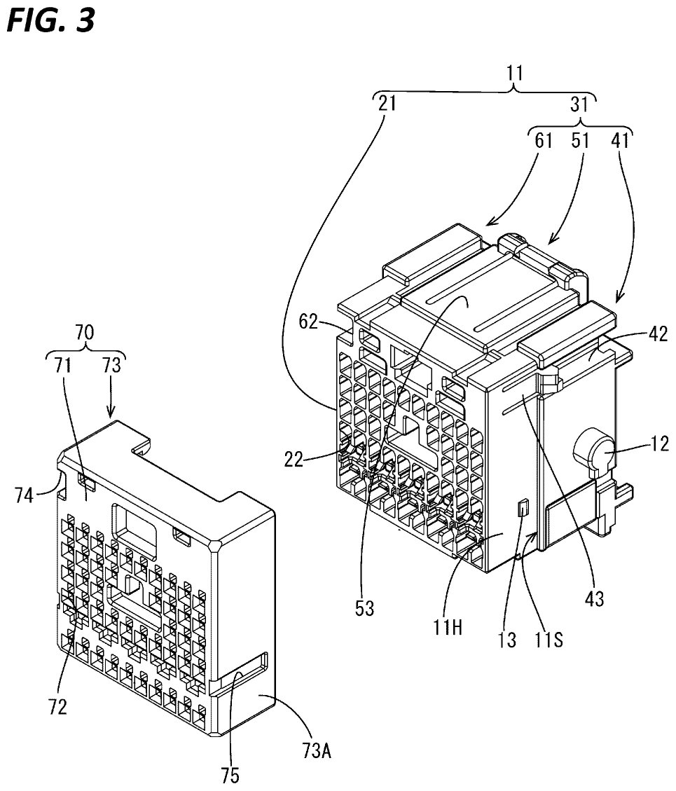

The connector housing 10 is made of a synthetic resin, and includes a housing body 11, two rotation shafts 12, and two holder latching protrusions 13 as shown in FIG. 3.

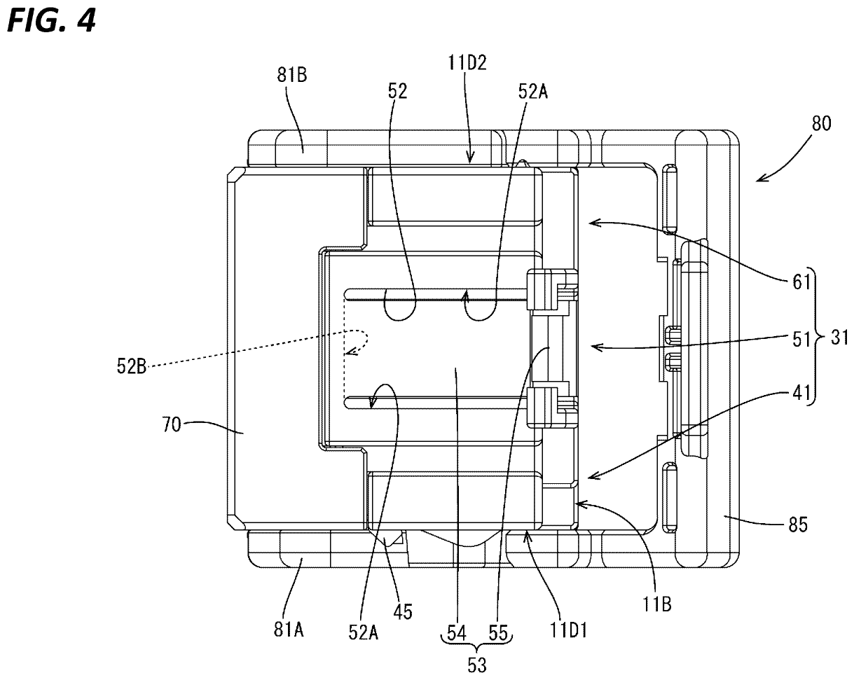

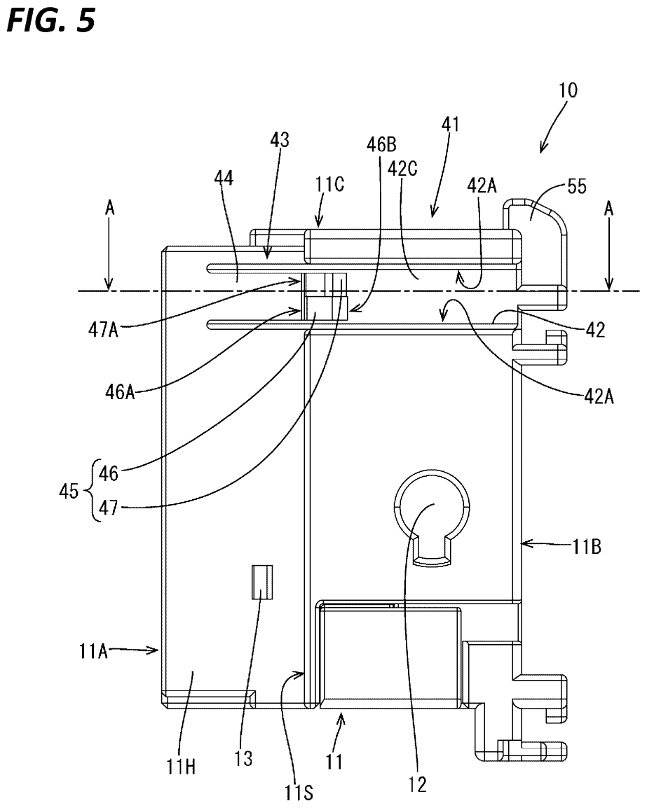

The housing body 11 is shaped as a rectangular parallelepiped overall, and, as shown in FIGS. 4 and 5, the front surface of the housing body 11 serves as a fitting surface 11A, the rear surface (surface on the opposite side to the fitting surface 11A) serves as an electric wire lead-out surface 11B, a surface perpendicular to the fitting surface 11A serves as a lock arrangement surface 11C, and two surfaces perpendicular to the fitting surface 11A and the lock arrangement surface 11C serve as a first lever attachment surface 11D1 (an example of lever attachment surface) and a second lever attachment surface 11D2. As shown in FIGS. 3 and 5, a portion of the housing body 11 that is adjacent to the fitting surface 11A serves as a holder attachment portion 11H that is slightly smaller than a portion on the rear side relative to the holder attachment portion 11H, and, on the lock arrangement surface 11C and the two lever attachment surfaces 11D1 and 11D2, a step surface 11S facing the fitting surface 11A side is disposed between the holder attachment portion 11H and a portion on the rear side relative to it.

As shown in FIG. 3, a portion of the housing body 11 that is adjacent to the lock arrangement surface 11C serves as a lock arrangement portion 31, and the other portion serves as a terminal holding portion 21.

As shown in FIG. 3, the terminal holding portion 21 includes a plurality of cavities 22 that pass therethrough between the fitting surface 11A and the electric wire lead-out surface 11B. A female terminal fitting and a terminal portion of an electric wire connected to the female terminal fitting are held in each of the cavities 22.

As shown in FIGS. 3 and 4, the lock arrangement portion 31 includes an initial lock portion 41 that is disposed adjacent to the first lever attachment surface 11D1, an attachment error preventing portion 61 that is disposed adjacent to the second lever attachment surface 11D2, and a fitting completion lock portion 51 that is disposed between the initial lock portion 41 and the attachment error preventing portion 61.

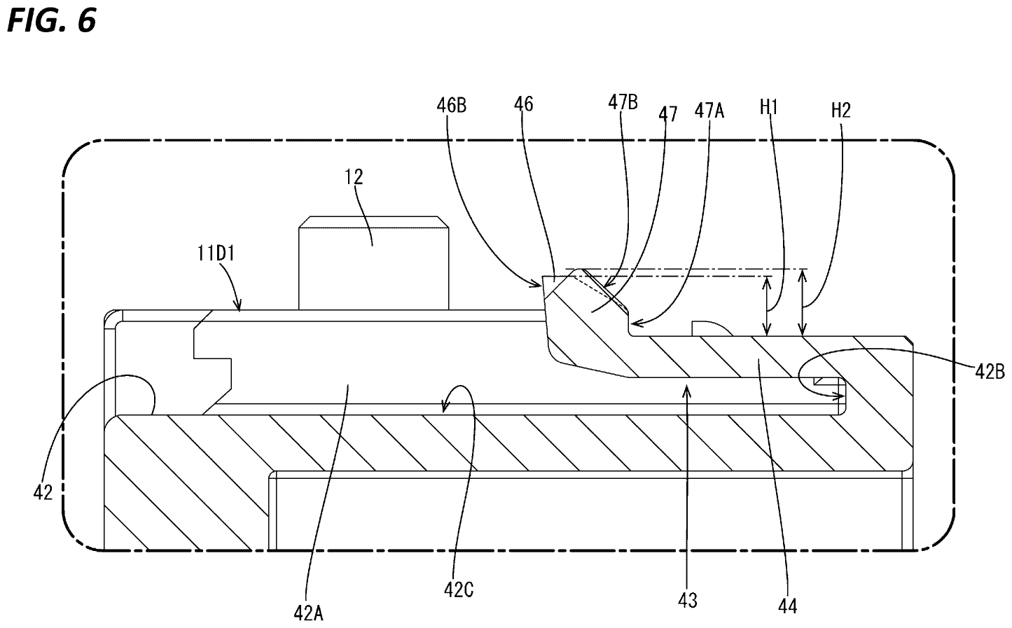

As shown in FIGS. 5 and 6, the initial lock portion 41 includes a first lock recessed portion 42 that is disposed in the first lever attachment surface 11D1, and a first lock arm 43 (an example of lock arm) that is disposed in the first lock recessed portion 42.

As shown in FIGS. 5 and 6, the first lock recessed portion 42 is a recessed portion defined by two first side surfaces 42A that are disposed perpendicularly to the first lever attachment surface 11D1 and are spaced apart from each other, a first further end surface 42B that connects end edges on the fitting surface 11A side of the two first side surfaces 42A, and faces the opposite side to the fitting surface 11A, and a first bottom surface 42C that connects the two first side surfaces 42A, and is parallel to the first lever attachment surface 11D1.

As shown in FIGS. 5 and 6, the first lock arm 43 includes a first arm portion 44 (an example of arm portion) and a first lock protrusion 45 (an example of lock protrusion) that protrudes from the first arm portion 44. The first arm portion 44 is shaped as a plate spring extending from the first further end surface 42B toward the electric wire lead-out surface 11B, and can flex in a direction perpendicular to the first lever attachment surface 11D1. The first lock protrusion 45 is disposed on the extending end of the first arm portion 44, and protrudes outward of the first lever attachment surface 11D1. The first lock protrusion 45 includes a first protrusion portion 46 that is latched to the lever 80 and a second protrusion portion 47 that is pressed by the partner connector 100. The first protrusion portion 46 and the second protrusion portion 47 are arranged in this order from the terminal holding portion 21 side.

As shown in FIGS. 5, 6, and 8, the surface of the first protrusion portion 46 that faces the fitting surface 11A side includes a first holder receiving surface 46A that is perpendicular to the first lever attachment surface 11D1, and the surface that faces the opposite side to the fitting surface 11A serves as a lever engagement surface 46B that is engaged with the lever 80. The lever engagement surface 46B is a steep surface that extends substantially perpendicularly to the first lever attachment surface 11D1. As shown in FIGS. 5 and 6, a surface of the second protrusion portion 47 that faces the fitting surface 11A side includes a second holder receiving surface 47A that is adjacent to the first holder receiving surface 46A, and is perpendicular to the first lever attachment surface 11D1, and a guide surface 47B that is disposed on a leading end side of the second protrusion portion 47 relative to the second holder receiving surface 47A, and is inclined in a direction separating away from the fitting surface 11A as it separates away from the first arm portion 44.

As shown in FIG. 6, a protrusion height H1 of the first protrusion portion 46 defined by the distance between an outer surface of the first arm portion 44 and the extending end of the first protrusion portion 46 is smaller than a protrusion height H2 of the second protrusion portion 47 defined by the distance between the outer surface of the first arm portion 44 and the extending end of the second protrusion portion 47.

As shown in FIG. 4, the fitting completion lock portion 51 includes a second lock recessed portion 52 that is disposed in the lock arrangement surface 11C and a second lock arm 53 (an example of fitting completion holding portion) that is disposed in the second lock recessed portion 52.

The second lock recessed portion 52 is a recessed portion defined by two second side surfaces 52A that are spaced apart from each other perpendicularly to the lock arrangement surface 11C, and a second further end surface 52B that connects the end edges on the fitting surface 11A side of the two second side surfaces 52A, and faces the opposite side to the fitting surface 11A.

The second lock arm 53 includes a second arm portion 54 and a second lock protrusion 55 that protrudes from the second arm portion 54. The second arm portion 54 is shaped as a plate spring extending from the second further end surface 52B toward the electric wire lead-out surface 11B. The second lock protrusion 55 protrudes outward of the lock arrangement surface 11C from the extending end of the second arm portion 54.

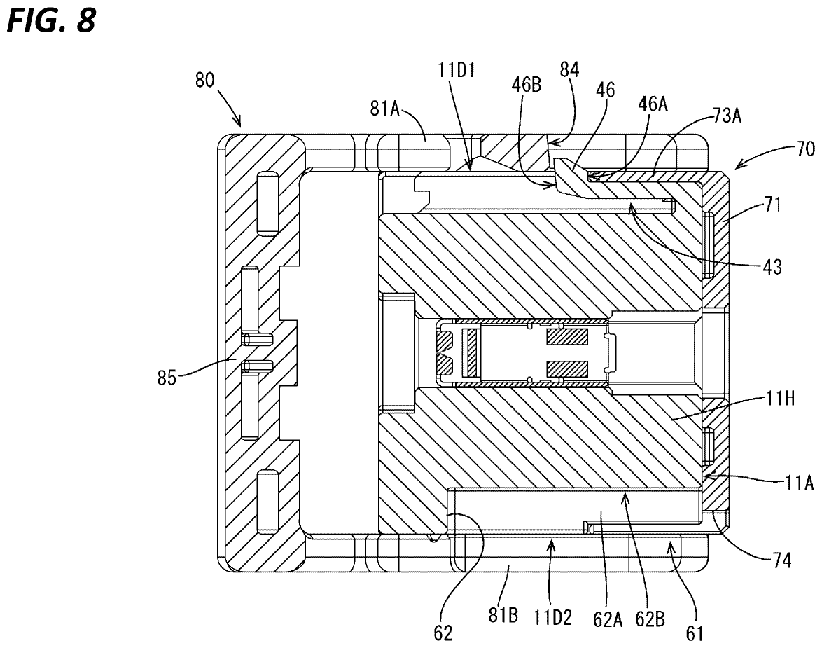

As shown in FIG. 8, the attachment error preventing portion 61 includes an attachment error preventing recessed portion 62 that is disposed in the second lever attachment surface 11D2. The attachment error preventing recessed portion 62 is a recessed portion defined by two third side surfaces 62A that are perpendicular to the second lever attachment surface 11D2, and are spaced apart from each other, and a second bottom surface 62B that connects the two third side surfaces 62A, and is parallel to the second lever attachment surface 11D2, and the attachment error preventing recessed portion 62 includes an opening portion in the fitting surface 11A.

As shown in FIGS. 3 and 5, the rotation shaft 12 and the holder latching protrusion 13 are disposed on the first lever attachment surface 11D1. The rotation shaft 12 is substantially cylindrical, and extends outward from the first lever attachment surface 11D1. The holder latching protrusion 13 is a protrusion that protrudes from the first lever attachment surface 11D1. The rotation shaft 12 and the holder latching protrusion 13 are also disposed on the second lever attachment surface 11D2, similarly.

### [Front Holder 70]

The front holder 70 is a member that covers the holder attachment portion 11H of the connector housing 10, and is made of a synthetic resin, and, as shown in FIGS. 3, 8, and 9, the front holder 70 includes a front wall 71 that is disposed along the fitting surface 11A, and a peripheral wall 73 that extends from the peripheral edge of the front wall 71 and surrounds the holder attachment portion 11H.

The front wall 71 retains terminal fittings that each form a portion of a wall that surrounds the cavity 22, and are disposed in the cavity 22. The front wall 71 includes a plurality of terminal insertion holes 72 that allow partner terminals of the partner connector 100 to enter. The terminal insertion holes 72 are in communication with the cavities 22, respectively. The peripheral wall 73 includes a first side wall 73A that is disposed along the first lever attachment surface 11D1 and a second side wall 73B that is disposed along the second lever attachment surface 11D2.

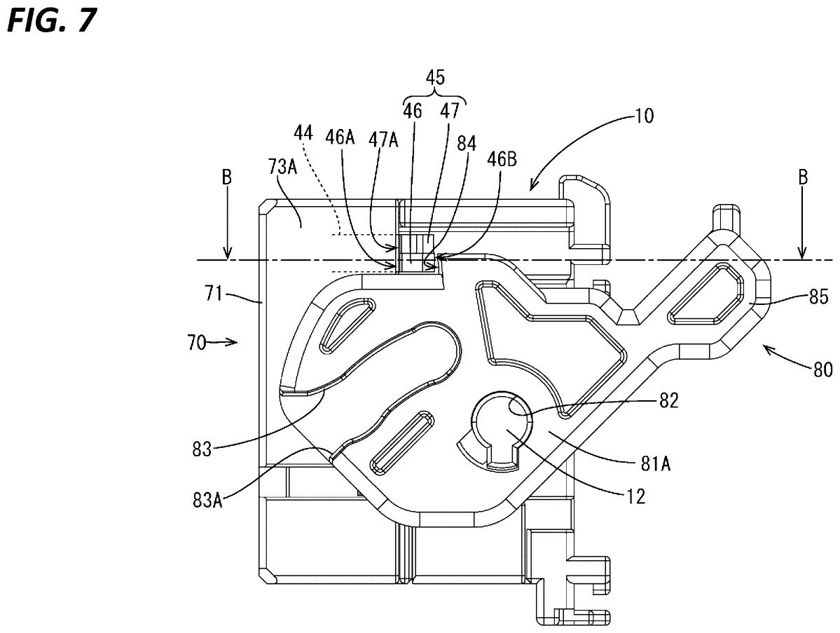

In a state where the front holder 70 is attached to the connector housing 10, the first side wall 73A covers the first arm portion 44 as shown in FIGS. 7 and 8. The first lock protrusion 45 is exposed from the front holder 70, and the extending end of the first side wall 73A is disposed adjacent to the first lock protrusion 45.

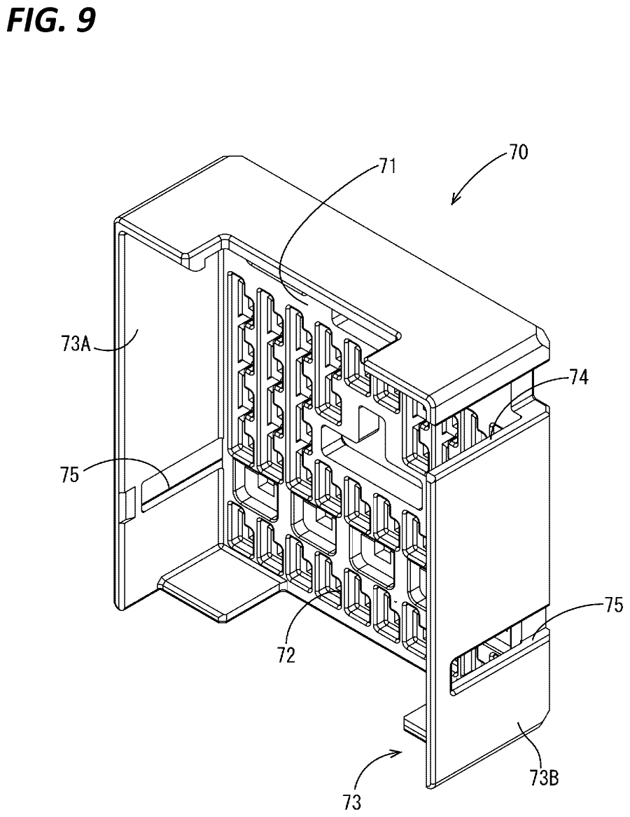

As shown in FIGS. 3 and 9, the front holder 70 includes a notch portion 74 that extends from the front wall 71 to the extending end of the second side wall 73B, and passes through the second side wall 73B. In a state where the front holder 70 is attached to the connector housing 10, the notch portion 74 is in communication with the attachment error preventing recessed portion 62 as shown in FIG. 8.

As shown in FIGS. 3 and 9, the front holder 70 includes two holder latching holes 75 that respectively pass through the first side wall 73A and the second side wall 73B, and receive the holder latching protrusions 13. As shown in FIG. 2, by the holder latching protrusions 13 entering the holder latching holes 75 and being latched to the hole edges of the holder latching holes 75, the front holder 70 is held on the connector housing 10.

### [Lever 80]

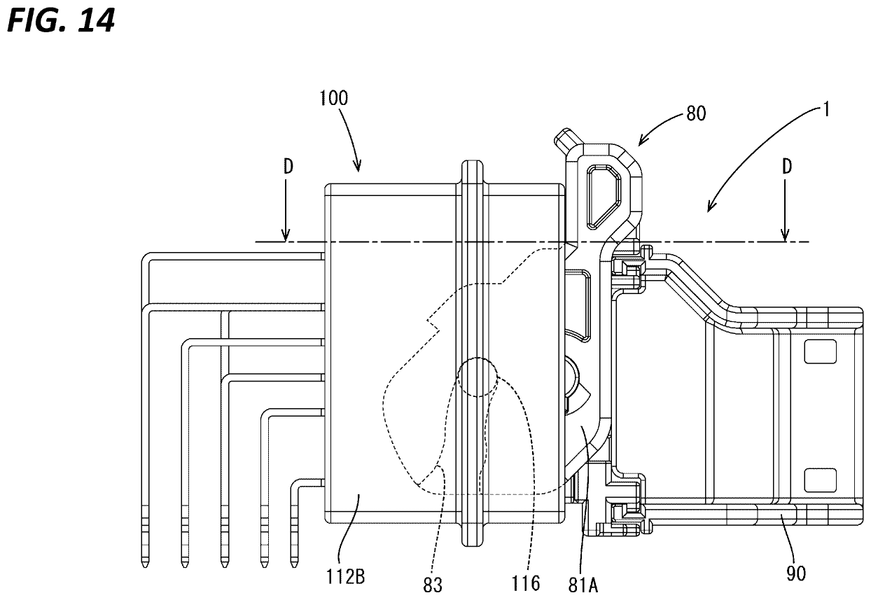

The lever 80 is a member for assisting fitting and detachment of the connector housing 10 to and from the partner connector 100 based on the principle of leverage, and is pivotally supported such that it can rotate about the rotation shaft 12 between an initial position (position shown in FIGS. 1, 7, and 12) and a fitting completion position (position shown in FIG. 14) where the partner connector 100 is in a state of being fitted to the connector housing 10 at the proper fitting position.

The lever 80 is made of a synthetic resin, and is a substantially U-shaped member that includes a first cam plate 81A that is disposed along the first lever attachment surface 11D1, a second cam plate 81B that is disposed along the second lever attachment surface 11D2, and a rotation operating portion 85 that couples the two cam plates 81A and 81B as shown in FIGS. 2 and 4.

As shown in FIGS. 2 and 7, the first cam plate 81A includes a shaft hole 82 and a cam groove 83. The shaft hole 82 is a substantially circular hole that passes through the first cam plate 81A, and into which the rotation shaft 12 is inserted. The cam groove 83 is a groove provided in the outer surface of the first cam plate 81A (surface on the opposite side to the second cam plate 81B), and has a cam entrance 83A on an outer edge of the first cam plate 81A. The cam groove 83 has a substantially arc-shape that gradually approaches the shaft hole 82 that is a rotation center of the first cam plate 81A, toward the farther side from the cam entrance 83A. The outer peripheral surface of the first cam plate 81A includes a latching receiving surface 84 that is engaged with the lever engagement surface 46B of the first protrusion portion 46 when the lever 80 is at the initial position.

The second cam plate 81B has a configuration similar to the first cam plate 81A except that the latching receiving surface 84 is not included, and thus the same constituent elements as the first cam plate 81A are given the same reference numerals, and a description thereof is omitted.

As shown in FIG. 2, the lever 80 includes a lock claw 86 that protrudes from the rotation operating portion 85. The lock claw 86 is a protrusion that protrudes from a central position between the two ends of the rotation operating portion 85.

### [Electric Wire Cover 90]

The electric wire cover 90 is a member for protecting electric wires led out from the cavities 22 by being attached to the connector housing 10 and covering the electric wire lead-out surface 11B. The electric wire cover 90 is made of a synthetic resin, and includes a main wall 91 and two side walls 92 extending from the main wall 91 as shown in FIG. 2. The main wall 91 is a wall that opposes the electric wire lead-out surface 11B. The two side walls 92 extend from two side edges of the main wall 91, respectively, and are disposed opposing each other. Note that, in consideration of the readability of the drawing, in FIGS. 4, 7, and 8, the electric wire cover 90 is omitted.

### [Partner Connector 100]

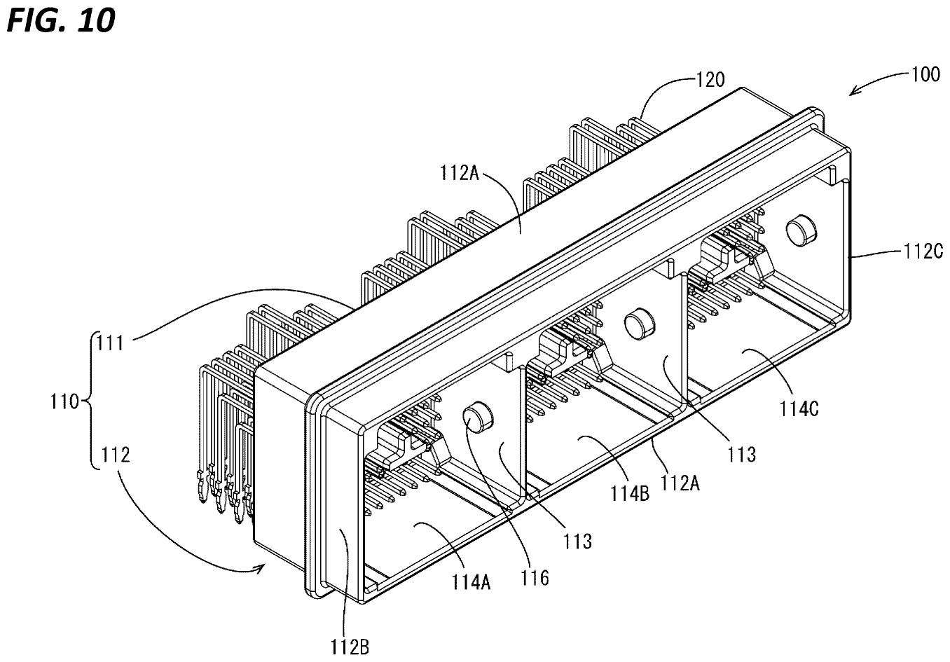

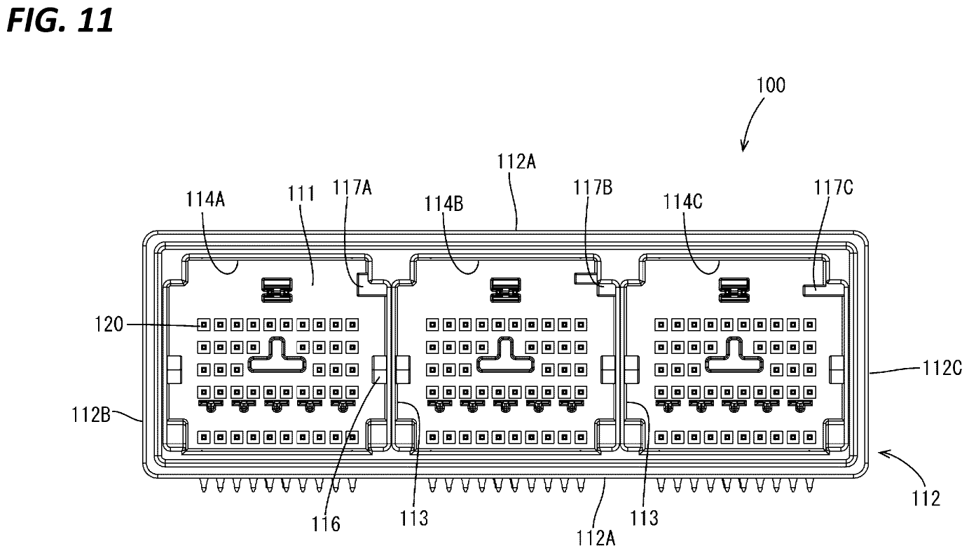

As shown in FIGS. 10 and 11, the partner connector 100 includes a partner housing 110 fittable with the connector housing 10, and a plurality of partner terminal fittings 120 attached to the partner housing 110.

The partner housing 110 is made of a synthetic resin, and includes a terminal holding wall 111, a hood portion 112, two partition walls 113, and three attachment error preventing protrusion portions 117A, 117B, and 117C as shown in FIGS. 10 and 11.

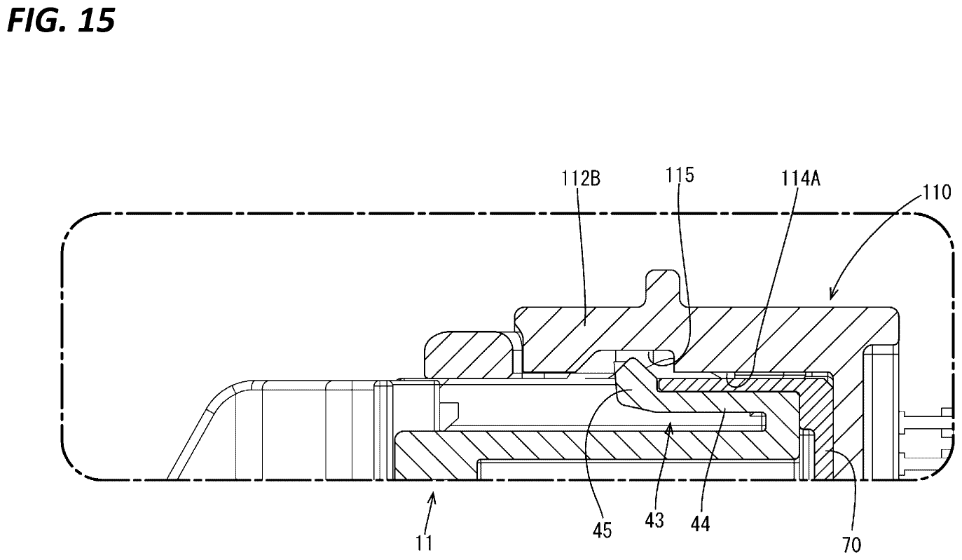

As shown in FIGS. 10 and 11, the terminal holding wall 111 is shaped as a rectangular plate. The hood portion 112 is shaped as a rectangular tube that extends from the terminal holding wall 111, and is constituted by two long walls 112A that oppose each other, a first short wall 112B that connects ends on one side of the two long walls 112A, and a second short wall 112C that connects ends on the other side of the two long walls 112A. The two partition walls 113 separate the internal space of the partner housing 110, which is disposed in the hood portion 112, and is defined by the terminal holding wall 111 and the hood portion 112, into three fitting spaces 114A, 114B, and 114C. The connector housing 10 is fitted into one fitting space, namely the fitting space 114A adjacent to the first short wall 112B, and other connector housings (not illustrated) are fitted into the other fitting spaces 114B and 114C. As shown in FIG. 15, the first short wall 112B includes a relief recessed portion 115. The relief recessed portion 115 is a recessed portion that is recessed from the inner surface of the first short wall 112B, and can receive the first lock protrusion 45.

As shown in FIGS. 10 and 11, the partner housing 110 includes six cylindrical cam followers 116. Cam followers 116 respectively protrude from the inner surfaces of two short walls 112B and 112C. Cam followers 116 also protrude respectively from the two surfaces of each of the two partition walls 113. In other words, inside each of the three fitting spaces 114A, 114B, and 114C, two cam followers 116 protrude as a pair.

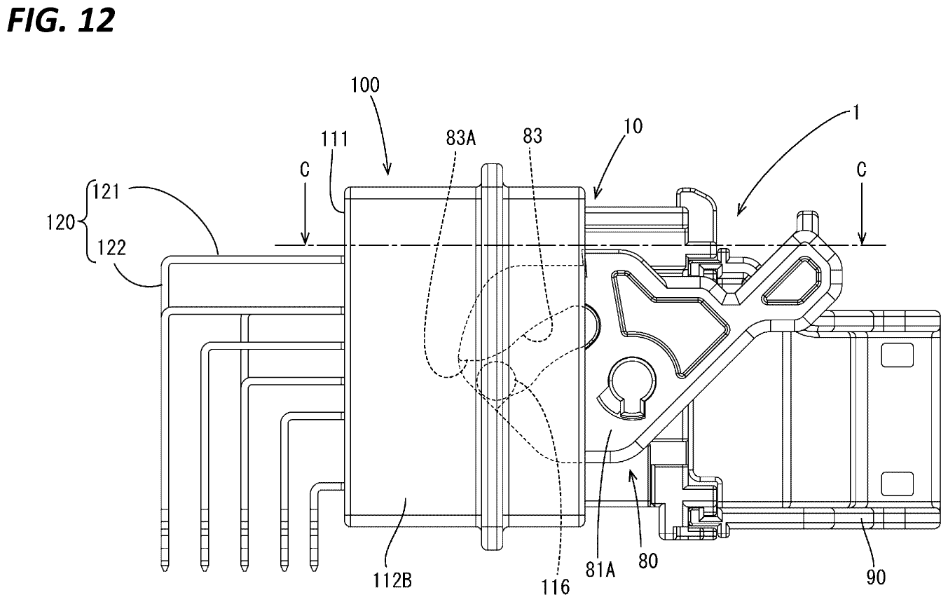

Each of the plurality of partner terminal fittings 120 is made of metal, is shaped as an L-shaped bar as shown in FIG. 12, and includes a tab portion 121 that passes through the terminal holding wall 111, and a connection portion 122 extending substantially vertically from one end of the tab portion 121.

As shown in FIG. 11, the three attachment error preventing protrusion portions 117A, 117B, and 117C are respectively disposed in the three fitting spaces 114A, 114B, and 114C. The three attachment error preventing protrusion portions 117A, 117B, and 117C have different shapes. The attachment error preventing recessed portion 62 and the notch portion 74 of the lever-type connector 1, which are fitted into the one fitting space 114A, can receive the attachment error preventing protrusion portion 117A disposed in the one fitting space 114A, but cannot receive the other attachment error preventing protrusion portions 117B and 117C respectively disposed in the other fitting spaces 114B and 114C.

### [Fitting Between Lever-Type Connector 1 and Partner Connector 100]

In a state where the lever-type connector 1 is not fitted to the partner connector 100, the lever 80 is held at the initial position and the lever engagement surface 46B of the first protrusion portion 46 abuts on the latching receiving surface 84 of the first cam plate 81A as shown in FIGS. 7 and 8, thus restricting rotation of the lever 80 from the initial position to the fitting completion position. The lever engagement surface 46B is a steep surface that extends substantially perpendicularly to a plane that includes the first lever attachment surface 11D1, and thus the intensity of fitting to the first cam plate 81A increases, and the lever 80 is reliably held at the initial position.

When an unexpected external force is applied to the lever 80, the lever 80 may rotate from the initial position to the fitting completion position against the latching force of the first protrusion portion 46. In such a case, there is concern that the first protrusion portion 46 will be pressed toward the fitting surface 11A by the first cam plate 81A, and the first lock arm 43 will flex and deform outward. However, in the present embodiment, the first arm portion 44 is covered by the first side wall 73A of the front holder 70, and thus deformation of the first arm portion 44 is suppressed. In addition, the extending end of the first side wall 73A is disposed adjacent to the second protrusion portion 47 and the first protrusion portion 46. Accordingly, even when the first protrusion portion 46 is pressed toward the fitting surface 11A by the first cam plate 81A, the holding force of the first protrusion portion 46 for holding the lever 80 is assisted by the first side wall 73A, and thus it is possible to reliably restrict unexpected rotation of the lever 80 to the fitting completion position.

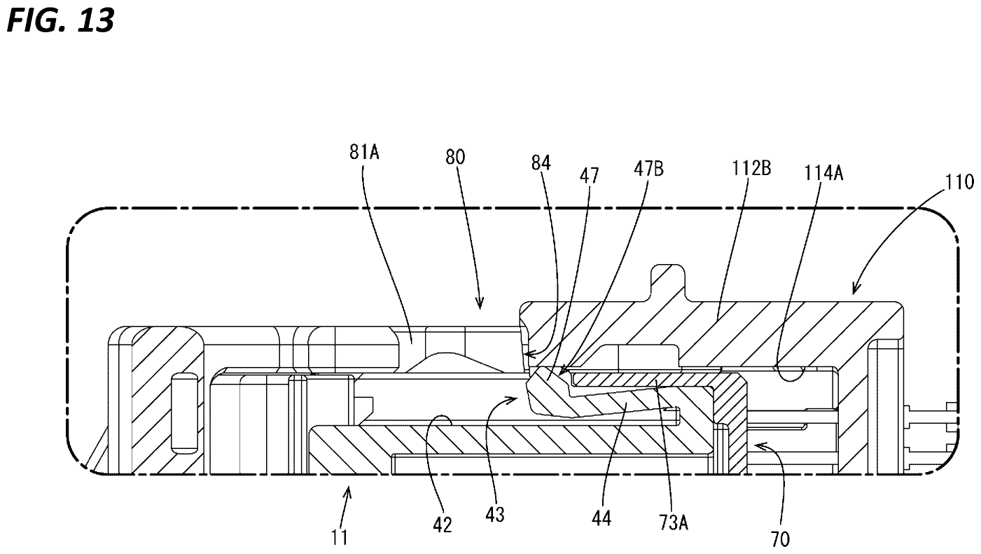

When the lever-type connector 1 is fitted to the partner connector 100, the connector housing 10 first enters the fitting space 114A of the partner connector 100 in a shallow manner. Then, as shown in FIG. 12, each cam follower 116 enters the cam groove 83 from the cam entrance 83A. In addition, as shown in FIG. 13, by the first short wall 112B climbing the second protrusion portion 47 while being guided to the guide surface 47B, the first arm portion 44 flexes inward, and the first lock protrusion 45 retracts into the first lock recessed portion 42. Accordingly, engagement between the first cam plate 81A and the first protrusion portion 46 is released, enabling the lever 80 to rotate to the fitting completion position. At this time, the protrusion height H1 of the first protrusion portion 46 is smaller than the protrusion height H2 of the second protrusion portion 47, and thus the first protrusion portion 46 reliably retracts into the first lock recessed portion 42, and engagement between the first cam plate 81A and the first protrusion portion 46 is reliably released.

Next, the lever 80 is rotated from the initial position toward the fitting completion position. As the lever 80 is rotated, the cam follower 116 moves toward the farther side of the cam groove 83, and due to the cam action that is based on engagement between the cam follower 116 and the cam groove 83, the connector housing 10 is attracted relative to the partner connector 100. When the lever 80 approaches the fitting completion position, the lock claw 86 climbs the second lock protrusion 55, and, as a result, the second lock arm 53 is flexed.

When the lever 80 reaches the fitting completion position, the connector housing 10 arrives at the proper fitting position relative to the partner connector 100 as shown in FIG. 14. By the second lock arm 53 elastically returning to the original shape thereof, and the lock claw 86 being engaged with the second lock protrusion 55, the lever 80 is held at the fitting completion position. In addition, as shown in FIG. 15, the first lock arm 43 elastically returns to the original shape thereof, and the first lock protrusion 45 is accommodated in the relief recessed portion 115.

In addition, the attachment error preventing protrusion portion 117A is accommodated in the attachment error preventing recessed portion 62. Note that, when the lever-type connector 1 mistakenly enters one of the other fitting spaces 114B and 114C, the attachment error preventing protrusion portion 117B or 117C cannot enter the attachment error preventing recessed portion 62, and the connector housing 10 cannot enter to the proper fitting completion position, thus enabling an attachment error to be detected.

### [Actions and Effects]

As described above, according to the present embodiment, the lever-type connector 1 includes: the connector housing 10 that has the fitting surface 11A and the first lever attachment surface 11D1 different from the fitting surface 11A, and is fitted to the partner connector 100, the front holder 70 that has the front wall 71 that is disposed along the fitting surface 11A and the peripheral wall 73 that extends from the front wall 71 and is disposed along the first lever attachment surface 11D1, and the lever 80 that is attached to the connector housing 10 such that the lever 80 can rotate from the initial position to the fitting completion position, the connector housing 10 includes the first lock arm 43 that has the first arm portion 44 that is flexibly disposed on the first lever attachment surface 11D1, and the first lock protrusion 45 that protrudes from the first arm portion 44, and is engaged with the lever 80 when the lever 80 is at the initial position, and the peripheral wall 73 covers the first arm portion 44.

With the above configuration, the first arm portion 44 is covered and protected by the peripheral wall 73, and thus it is possible to avoid unexpected deformation of the first lock arm 43 due to an external force being applied. In addition, the peripheral wall 73 of the front holder 70 is used as a protection wall of the first arm portion 44, and thus the first lock arm 43 can be protected without increasing the size of the connector.

In addition, the peripheral wall 73 is disposed adjacent to the first lock protrusion 45 on the opposite side to the lever 80. According to such a configuration, the holding force of the first lock protrusion 45 for holding the lever 80 is assisted by the peripheral wall 73, and thus it is possible to reliably restrict unintended rotation of the lever 80 to the fitting completion position by an external force being applied.

In addition, the first lock protrusion 45 includes the first protrusion portion 46 that has the lever engagement surface 46B that is engaged with the lever 80 when the lever 80 is at the initial position, and the second protrusion portion 47 that has the guide surface 47B inclined in a direction separating away from the fitting surface 11A as it separates away from the first arm portion 44.

According to such a configuration, the first lock protrusion 45 includes the plurality of protrusion portions 46 and 47, and thus the protrusion portions 46 and 47 can be assigned different roles, thus increasing the degree of freedom of design.

In addition, the connector housing 10 includes the terminal holding portion 21 that includes cavities 22 capable of accommodating terminal fittings, and the lock arrangement portion 31 disposed at a position different from the terminal holding portion 21, and the lock arrangement portion 31 includes the first lock arm 43 and the second lock arm 53 that is engaged with the lever 80 when the lever 80 is at the fitting completion position.

With such a configuration, a structure for holding the lever 80 at the initial position and the fitting completion position is collectively disposed in the lock arrangement portion 31, and thus it is possible to avoid complication of the configuration of the connector housing 10.

### Other Embodiments

(1) In the above embodiment, the lock arm is disposed on only one side of the connector housing, but lock arms may be disposed on the two sides of the connector housing, respectively.

(2) In the above embodiment, the front member is a front holder that forms a portion of the wall that surrounds the cavities, but the front member may be a front retainer that is engaged with terminal fittings disposed in the cavities to retain the terminal fittings, for example.

(3) In the above embodiment, the fitting completion holding portion is the second lock arm, but the fitting completion holding portion may be a lock claw that is engaged with the lock arm provided on the lever, for example.

List of Reference Numerals

| | |
|---|---|
| 1 | Lever-type connector |
| 10 | Connector housing |
| 11 | Housing body |
| 11A | Fitting surface |
| 11B | Electric wire lead-out surface |
| 11C | Lock arrangement surface |
| 11D1 | First lever attachment surface (lever attachment |
| | surface) |
| 11D2 | Second lever attachment surface |
| 11H | Holder attachment portion |
| 11S | Step surface |
| 12 | Rotation shaft |
| 13 | Holder latching protrusion |
| 21 | Terminal holding portion |
| 22 | Cavity |
| 31 | Lock arrangement portion |
| 41 | Initial lock portion |
| 42 | First lock recessed portion |
| 42A | First side surface |
| 42B | First further end surface |
| 42C | First bottom surface |
| 43 | First lock arm (lock arm) |
| 44 | First arm portion (arm portion) |
| 45 | First lock protrusion (lock protrusion) |
| 46 | First protrusion portion |
| 46A | First holder receiving surface |
| 46B | Lever engagement surface |
| 47 | Second protrusion portion |
| 47A | Second holder receiving surface |
| 47B | Guide surface |
| 51 | Fitting completion lock portion |
| 52 | Second lock recessed portion |
| 52A | Second side surface |
| 52B | Second further end surface |
| 53 | Second lock arm (fitting completion holding |
| | portion) |
| 54 | Second arm portion |
| 55 | Second lock protrusion |
| 61 | Attachment error preventing portion |
| 62 | Attachment error preventing recessed portion |
| 62A | Third side surface |
| 62B | Second bottom surface |
| 70 | Front holder |
| 71 | Front wall |
| 72 | Terminal insertion hole |
| 73 | Peripheral wall |
| 73A | First side wall |
| 73B | Second side wall |
| 74 | Notch portion |
| 75 | Holder latching hole |
| 80 | Lever |
| 81A | First cam plate |
| 81B | Second cam plate |
| 82 | Shaft hole |
| 83 | Cam groove |
| 83A | Cam entrance |
| 84 | Latching receiving surface |
| 85 | Rotation operating portion |
| 86 | Lock claw |
| 90 | Electric wire cover |
| 91 | Main wall |
| 92 | Side wall |
| 100 | Partner connector |
| 110 | Partner housing |
| 111 | Terminal holding wall |
| 112 | Hood portion |
| 112A | Long wall |
| 112B | First short wall |
| 112C | Second short wall |
| 113 | Partition wall |
| 114A, 114B, 114C | Fitting space |
| 115 | Relief recessed portion |
| 116 | Cam follower |
| 117A, 117B, 117C | Attachment error preventing protrusion portion |
| 120 | Partner terminal fitting |
| 121 | Tab portion |
| 122 | Connection portion |
| H1 | Protrusion height of first protrusion portion |
| H2 | Protrusion height of second protrusion portion |

1. A lever-type connector comprising:
a connector housing that has a fitting surface and a lever attachment surface different from the fitting surface, and is fitted to a partner connector;
a front member that has a front wall disposed along the fitting surface and a peripheral wall extending from the front wall and disposed along the lever attachment surface; and
a lever that is attached to the connector housing such that the lever is rotatable from an initial position to a fitting completion position,
wherein the connector housing includes:
a lock arm that has an arm portion that is flexibly disposed on the lever attachment surface, and a lock protrusion that protrudes from the arm portion, and is engaged with the lever when the lever is at the initial position, and
the peripheral wall covers the arm portion.

2. The lever-type connector according to claim 1,
wherein the peripheral wall is disposed adjacent to the lock protrusion, on an opposite side to the lever.

3. The lever-type connector according to claim 1,
wherein the lock protrusion includes a first protrusion portion that has a lever engagement surface that is engaged with the lever when the lever is at the initial position, and a second protrusion portion that has a guide surface inclined in a direction separating away from the fitting surface as it separates away from the arm portion.

4. The lever-type connector according to claim 1,
wherein the connector housing includes: a terminal holding portion that has a cavity capable of accommodating a terminal fitting, and a lock arrangement portion disposed at a position different from the terminal holding portion, and
the lock arrangement portion includes the lock arm and a fitting completion holding portion that is engaged with the lever when the lever is at the fitting completion position.
